(19) United States
(12) Patent Application Publication
(10) Pub. No.: US 2025/0119813 A1
(43) Pub. Date: Apr. 10, 2025

(54) TRANSMISSION CHANNEL SWITCHING METHOD AND APPARATUS THEREOF

(71) Applicant: MEDIATEK INC., Hsinchu City (TW)

(72) Inventors: Wei-Shuo CHEN, Hsinchu City (TW); Kun-Lin WU, Hsinchu City (TW); Pang-Hsin SHIH, Hsinchu City (TW); Yuan-Chin WEN, Hsinchu City (TW); Te-Hsin LIN, Hsinchu City (TW); Cheng-Che CHEN, Hsinchu City (TW)

(21) Appl. No.: 18/893,200

(22) Filed: Sep. 23, 2024

Related U.S. Application Data
(60) Provisional application No. 63/588,309, filed on Oct. 6, 2023.

(51) Int. Cl. H04W 40/12; H04W 40/10; H04W 84/12

(52) U.S. Cl. CPC H04W 40/12; H04W 40/10; H04W 84/12

(57) ABSTRACT

A transmission channel switching method is provided. The transmission channel switching method may include the following steps. An apparatus may establish a plurality of transmission channels. The apparatus may transmit data through a default transmission channel of the transmission channels, wherein the default transmission channel corresponds to the lowest power consumption. The apparatus may determine whether to switch to another transmission channel of the transmission channels according to channel quality of each transmission channel and power consumption corresponds to each transmission channel.

### CROSS-REFERENCE TO RELATED APPLICATIONS

This application claims the benefits of U.S. Provisional Application No. 63/588,309 filed on Oct. 6, 2023, the entirety of which is incorporated by reference herein.

### BACKGROUND OF THE INVENTION

### Field of the Invention

The invention generally relates to wireless communication technology, and more particularly, it relates to a transmission channel switching technology in which the transmission channel is switched according to the channel quality and the power consumption.

### Description of the Related Art

As demand for ubiquitous computing and networking has grown, various wireless technologies have been developed, including Wireless-Fidelity (Wi-Fi) which is a Wireless Local Area Network (WLAN) technology allowing mobile devices (such as smartphones, smart pads, laptop computers, portable multimedia players, embedded apparatuses, and the like) to obtain wireless services in a frequency band of 2.4 GHz, 5 GHz, 6 Gz or 60 GHz.

When users use mobile devices, the network latency may affect user experience, and power consumption may affect long-term use of mobile devices. Therefore, they are both very important to users. The network latency may vary in different environments, and the power consumption may be different on different platforms. In conventional technologies, the mobile devices can perform data transmission through a modem (MD) channel or Wi-Fi channel. In order to achieve better transmission quality for network latency, the mobile devices may further transmit data through a dual-channel transmission mode, i.e. the mobile devices may use the MD channel and the Wi-Fi channel to transmit data at the same time. However, when the mobile devices are operated in the dual-channel transmission mode, the power consumption will be increased.

Therefore, how to efficiently and flexibly switch the transmission channels by referring to the network latency and power consumption at the same time is a topic that is worthy of discussion.

### BRIEF SUMMARY OF THE INVENTION

A transmission channel switching method and apparatus are provided to overcome the problems mentioned above.

An embodiment of the invention provides a transmission channel switching method. The transmission channel switching method may include the following steps. An apparatus may establish a plurality of transmission channels. The apparatus may transmit data through the default transmission channel of the transmission channels, wherein the default transmission channel corresponds to the lowest power consumption. The apparatus may determine whether to switch to another transmission channel of the transmission channels according to channel quality of each transmission channel and power consumption corresponds to each transmission channel.

In some embodiment, the transmission channels may comprise at least one Wi-Fi transmission channel and at least one modem (MD) transmission channel.

In some embodiments, the apparatus may determine whether the channel quality of the default transmission channel meeting a switching condition, and determine whether the power consumption corresponding to the default transmission channel is changed so that it is higher than a threshold.

In some embodiments, the switching condition may be associated with transmission timeout time, signal quality, packet error rate, block error rate, network congestion status, network latency time, or a combination thereof.

In some embodiments, when the channel quality of the default transmission channel does not meet the switching condition and the power consumption corresponding to the default transmission channel is not higher than the threshold, the apparatus may keep using the default transmission channel to transmit the data.

In some embodiments, when the channel quality of the default transmission channel meets the switching condition, the apparatus may determine whether there is a second transmission channel of the plurality of transmission channels whose channel quality does not meet the switching condition, and switch to the second transmission channel when there is the second transmission channel whose channel quality does not meet the switching condition.

In some embodiments, the apparatus may further transmit the data through a dual-channel transmission mode when there is no transmission channel whose channel quality does not meet the switching condition.

In some embodiments, the apparatus may further switch back to a single-channel transmission mode when there is at least one transmission channel whose channel quality does not meet the switching condition.

In some embodiments, the apparatus may further determine whether there is at least one transmission channel whose channel quality does not meet the switching condition when the power consumption corresponding to the second transmission channel is higher than the threshold. The apparatus may further switch from the second transmission channel to a transmission channel whose channel quality does not meet the switching condition when there is this transmission channel whose channel quality does not meet the switching condition.

An embodiment of the invention provides a transmission channel switching apparatus. The transmission channel switching apparatus includes a modem module, a Wi-Fi module, and a processor. The modem module may be configured to perform wireless transmission and reception to and from a network node. The Wi-Fi module may be configured to perform Wi-Fi transmission and reception. The processor may be coupled to the modem module and the Wi-Fi module. The processor may be configured to establish a plurality of transmission channels. The processor may be also configured to transmit data through a default transmission channel of the plurality of transmission channels via the modem module or the Wi-Fi module, wherein the default transmission channel may correspond to the lowest power consumption. The processor may be further configured to determine whether to switch to another transmission channel of the plurality of transmission channels according to channel quality of each transmission channel and power consumption corresponds to each transmission channel.

Other aspects and features of the invention will become apparent to those with ordinary skill in the art upon review of the following descriptions of specific embodiments of transmission channel switching method and an apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a transmission channel switching according to an embodiment of the invention.

FIG. 5 is a flow chart illustrating a transmission channel switching method according to another embodiment of the invention.

### DETAILED DESCRIPTION OF THE DISCLOSURE

The following description is of the best-contemplated mode of carrying out the invention. This description is made for the purpose of illustrating the general principles of the invention and should not be taken in a limiting sense. The scope of the invention is best determined by reference to the appended claims.

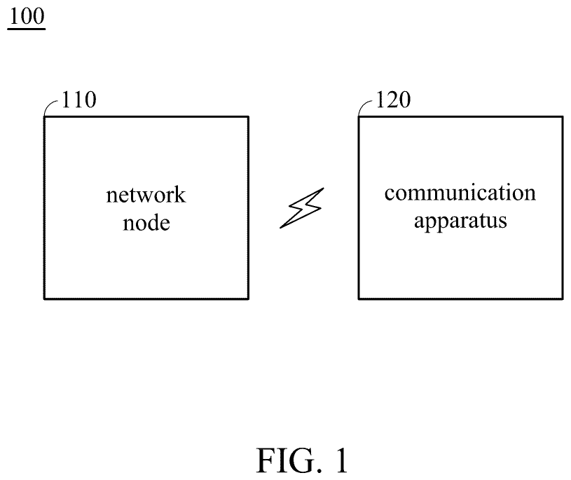

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point, an access terminal, but the invention should not be limited thereto. In the embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto.

In the embodiments of the invention, the communication apparatus 120 may be a user equipment (UE), a non-AP station (STA), a smartphone, Personal Data Assistant (PDA), pager, laptop computer, desktop computer, wireless handset, or any computing device that includes a wireless communications interface. In addition, the communication apparatus 120 may be an entity compatible with the Institute of Electrical and Electronics Engineers (IEEE) 802.11 standards.

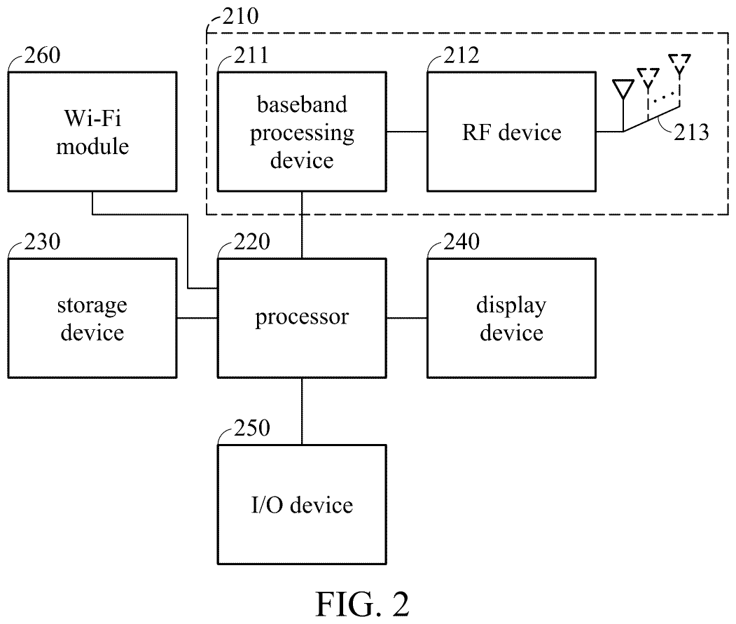

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a modem module 210, a processor 220, a storage device 230, a display device 240, an Input/Output (I/O) device 250, and a Wi-Fi module 260.

The modem module 210 may be configured to perform wireless transmission and reception to and from the communication apparatus 120.

Specifically, the modem module 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the modem module 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the modem module 210, the storage device 230, the display device 240, the I/O device 250, and the Wi-Fi module 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi module 260 may comprise Wi-Fi antenna and may be configured to perform the operations of Wi-Fi communications with an access point (AP). According to an embodiment of the invention, the AP may be an Extremely High Throughput (EHT) AP which is compatible with the IEEE 802.11be standards. In another embodiment of the invention, the AP may be an AP which is compatible with any IEEE 802.11 standards later than 802.11be. According to an embodiment of the invention, the Wi-Fi module 260 may support multi-channel transmission, i.e., the Wi-Fi module 260 may comprise a plurality of Wi-Fi transmission channels.

According to an embodiment of the invention, the modem module 210 may be configured in a modem (MD) of the communication apparatus 200, and the processor 220 may be configured in an application processor (AP) or a platform of the communication apparatus 200. According to an embodiment of the invention, the MD may support multi-channel transmission, i.e., the MD may comprise a plurality of MD transmission channels.

It should be understood that the components described in the embodiment of FIG. 2 are for illustrative purposes only and are not intended to limit the scope of the application. For example, a communication apparatus may include more components, such as another modem module for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

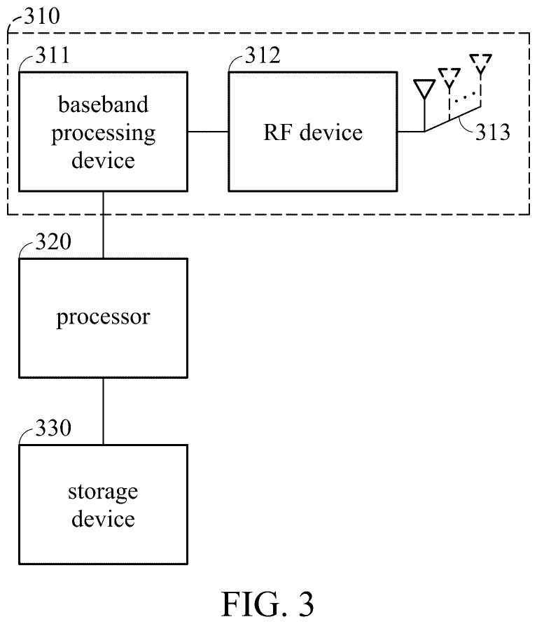

FIG. 3 is a block diagram illustrating a network node 300 according to an embodiment of the application. The network node 300 can be applied to the network node 110. As shown in FIG. 3, the network node 300 may comprise a modem module 310, a processor 320, and a storage device 330.

The modem module 310 is configured to perform wireless transmission and reception to and from one or more communication apparatuses (e.g., the communication apparatus 120).

Specifically, the modem module 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the modem module 310 for wireless communications with the communication apparatus 120, and storing and retrieving data (e.g., program code) to and from the storage device 330.

In particular, the processor 320 coordinates the aforementioned operations of the modem module 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, when an application (e.g., a cloud game, but the invention should not be limited thereto) is performed on an apparatus (e.g., communication apparatus 120), the apparatus may establish a plurality of transmission channels. The transmission channels may comprise at least one Wi-Fi transmission channel (i.e., the Wi-Fi module of the apparatus may support multi-channel transmission) and at least one MD transmission channel (i.e., the modem module of the apparatus may support multi-channel transmission).

Then, the apparatus may transmit data associated with the application through the default transmission channel of the transmission channels. The default transmission channel may correspond to the lowest power consumption. That is, when the apparatus uses the default transmission channel to transmit data in normal transmission status, the lowest power consumption will be generated. However, as the network environment is changed (e.g., the apparatus is leaving the service range of a network node or an AP), the power consumption corresponding to the transmission channels may be changed. For example, the power consumption of the apparatus may be increased when the apparatus leaves the service range of a network node or an AP.

Then, the apparatus may determine whether to switch to another transmission channel of the transmission channels according to the channel quality (or network quality) of each transmission channel and the power consumption corresponding to each transmission channel. Specifically, the apparatus may determine whether the channel quality of the default transmission channel meets a switching condition (i.e., the channel quality of the default transmission channel becomes worse), and determine whether the power consumption corresponding to the default transmission channel is higher than a threshold (i.e., the power consumption of the apparatus being increased when the default transmission channel is used to transmit data).

According to an embodiment of the invention, the switching condition may be associated with at least one of a transmission (TX) timeout time, a signal quality, a packet error rate, a block error rate, a network congestion status, and a network latency, but the invention should not be limited thereto. For example, if the number of times of the TX timeout time corresponding to a transmission channel being longer than the default time (e.g., 5 millisecond (ms)) is larger than a threshold in a period of time (e.g., 7 times in 10 second(s)), the apparatus may determine that the channel quality of the transmission channel meets the switching condition, i.e., the apparatus may need to switch the current transmission channel. The above example is just an embodiment of the invention, but the invention should not be limited thereto.

According to an embodiment of the invention, when the channel quality of the default transmission channel does not meet the switching condition (i.e., the current channel quality of the default transmission channel is good enough) and the power consumption corresponding to the default transmission channel is not higher than the threshold, the apparatus may keep using the default transmission channel to transmit the data.

According to an embodiment of the invention, when the channel quality of the default transmission channel meets the switching condition (i.e., the channel quality of the default transmission channel becomes worse), the apparatus may determine whether there is at least one transmission channel of the transmission channels whose channel quality does not meet the switching condition. If there is at least one transmission channel (e.g., the second transmission channel) whose channel quality does not meet the switching condition, the apparatus may switch from the default transmission channel to one transmission channel whose channel quality does not meet the switching condition.

In an example, if the apparatus comprises one Wi-Fi transmission channel and one MD transmission channel, and the default transmission channel is the Wi-Fi transmission channel, when the channel quality of the Wi-Fi transmission channel becomes worse (i.e., meet the switching condition) and the channel quality of the MD transmission channel is good enough (i.e., not meet the switching condition), the apparatus may switch from the Wi-Fi transmission channel to the MD transmission channel, i.e., the apparatus may change to use the MD transmission channel to transmit data.

In another example, if the apparatus comprises one Wi-Fi transmission channel and one MD transmission channel, and the default transmission channel is the MD transmission channel, when the channel quality of the MD transmission channel becomes worse (i.e., meet the switching condition) and the channel quality of the Wi-Fi transmission channel is good enough (i.e., not meet the switching condition), the apparatus may switch from the MD transmission channel to the Wi-Fi transmission channel, i.e., the apparatus may change to use the Wi-Fi transmission channel to transmit data.

In another example, if the apparatus comprises more than one Wi-Fi transmission channel and more than one MD transmission channel, when the default transmission channel becomes worse (i.e., meet the switching condition) and the channel quality of at least one of other transmission channels is good enough (i.e., it does not meet the switching condition), the apparatus may select one transmission channel with the best channel quality and switch from the default transmission channel to the selected transmission channel, i.e., the apparatus may change to use the selected transmission channel to transmit data. Specifically, when the apparatus comprises dual Wi-Fi transmission channels (or multi-Wi-Fi transmission channels) and dual MD transmission channels (or multi-MD transmission channels), the apparatus may select one (or at least one) Wi-Fi transmission channel with the best channel quality from the Wi-Fi transmission channels, and select one (or at least one) MD transmission channel with the best channel quality from the MD transmission channels. Then, the apparatus may select one transmission channel with the best channel quality from the selected Wi-Fi transmission channel and the selected MD transmission channel. Then, according to the switch condition, the apparatus may determine to switch from the default transmission channel to the selected transmission channel with the best channel quality, or transmit the data through a dual-channel transmission mode (i.e., the apparatus may use both of the selected Wi-Fi transmission channel and the selected MD transmission channel).

After the apparatus switch from the default transmission channel to another transmission channel whose channel quality is good enough, the apparatus may continuously detect whether the power consumption corresponding to the transmission channel currently in use is changed so that it is higher than a threshold (i.e., the current power consumption of the apparatus is too high), or the channel quality of the transmission channel currently in use becomes worse. When the power consumption corresponding to the transmission channel currently in use is changed so that it is higher than the threshold, or the channel quality of the transmission channel currently in use becomes worse, the apparatus may determine whether there is at least one appropriate transmission channel can be used. If there is at least one appropriate transmission channel can be used (e.g., the transmission channel whose channel quality does not meet the switching condition, and its corresponding power consumption is not higher than the threshold), the apparatus may switch from the transmission channel currently in use to an appropriate transmission channel.

According to an embodiment of the invention, when the channel quality of the default transmission channel meets the switching condition (i.e., the channel quality of the default transmission channel becomes worse), and all other transmission channels also meet the switching condition, the apparatus may determine to transmit the data through a dual-channel transmission mode. That is, the qualities of the MD network and the Wi-Fi network are both not good enough. Therefore, the apparatus may use more than one transmission channels to transmit data to reduce the network latency and maintain the user experience.

In addition, because the dual-channel transmission mode may generate more power consumption, the apparatus may continuously determine whether there is at least one transmission channel whose channel quality does not meet the switching condition (i.e., the channel quality is good enough). When there is at least one transmission channel whose channel quality has not meet the switching condition, the apparatus may switch back to the single-channel transmission mode to reduce the power consumption, i.e., the apparatus may determine to transmit the data through one transmission channel. For example, when the apparatus determine that the received signal strength indictor (RSSI) of the MD network (or the Wi-Fi network) has been above a threshold (e.g., −55 dBm), the apparatus may change to transmit the data through one MD transmission channel (or Wi-Fi transmission channel), i.e., switch back to the single-channel transmission mode, but the invention should not be limited thereto.

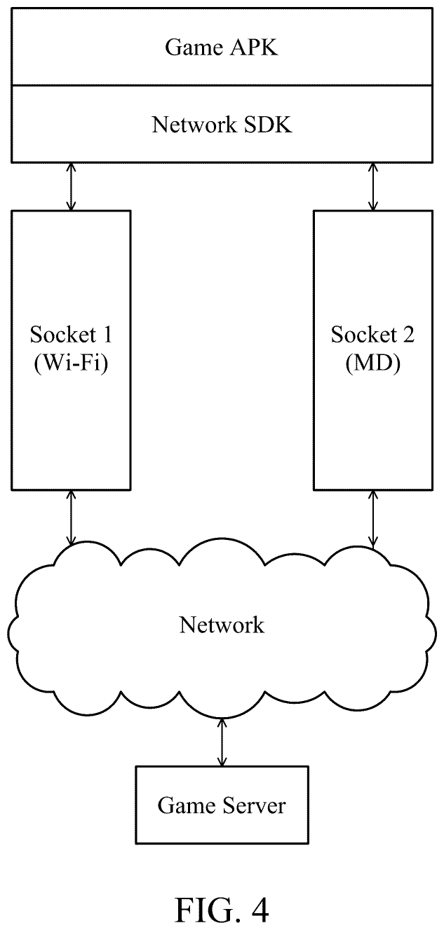

FIG. 4 is a schematic diagram illustrating a transmission channel switching according to an embodiment of the invention. As shown in FIG. 4, the apparatus may comprise one Wi-Fi transmission channel (i.e., socket 1) and one MD transmission channel (i.e., socket 2). It is assumed that the default transmission channel is the Wi-Fi transmission channel (i.e., socket 1) corresponding to lower power consumption. That is, when the apparatus performs an application (e.g., cloud game), the apparatus may use the Wi-Fi transmission channel to transmit data (or packets) of the application initially. In an example, when the number of occurring the condition of “TX timeout >5 ms” in the Wi-Fi transmission channel (i.e., default transmission channel) has exceeded the threshold (e.g., 7 times within 10 s), i.e., the channel quality of the Wi-Fi transmission channel becomes worse, the apparatus may switch from the Wi-Fi transmission channel to the MD transmission channel with better channel quality to transmit the packets of the application (e.g., packets from the game Android Package (APK) and network software development kit (SDK). In addition, after the apparatus switches from the Wi-Fi transmission channel to the MD transmission channel, if the power consumption corresponding to the MD transmission channel becomes higher (e.g. the apparatus may be far from gNB and use more Tx power), and the current quality of Wi-Fi network is good enough (i.e., the channel quality of the Wi-Fi transmission channel is good enough currently), the apparatus may determine switch back to the Wi-Fi transmission channel. In addition, when the channel qualities of both MD transmission channel and Wi-Fi transmission channel are not good (e.g., the number of occurring the condition of “TX timeout >5 ms” in the Wi-Fi transmission channel and the number of occurring the condition of “TX timeout >5 ms” in the MD transmission channel both have exceeded the threshold (e.g., 7 times within 10 s)) the apparatus may transmit data through dual-channel transmission mode, i.e., through the MD transmission channel and the Wi-Fi transmission channel. In addition, during the apparatus in the dual-channel transmission mode, if the RSSI of the Wi-Fi network or modem network has been higher than −55 dBm (i.e., the channel quality of the MD transmission channel or the Wi-Fi transmission channel becomes good enough), the apparatus may determine switch back to single-channel transmission mode to reduce power consumption.

It should be noted that FIG. 4 is only used to illustrate an embodiment of the invention, but the invention should not be limited thereto.

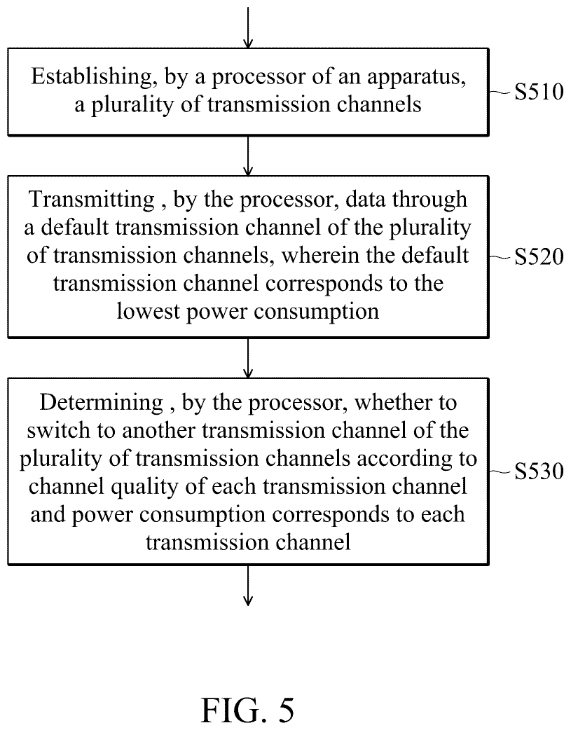

FIG. 5 is a flow chart illustrating a transmission channel switching method according to an embodiment of the invention. The transmission channel switching method can be applied to the communication apparatus 120 of the wireless communications system 100. As shown in FIG. 5, in step S510, the processor of the communication apparatus 120 may establish a plurality of transmission channels.

In step S520, the processor of the communication apparatus 120 may transmit data through a default transmission channel of the plurality of transmission channels. The default transmission channel may correspond to the lowest power consumption.

In step S530, the processor of the communication apparatus 120 may determine whether to switch to another transmission channel of the plurality of transmission channels according to the channel quality of each transmission channel and the power consumption corresponding to each transmission channel.

According to an embodiment of the invention, in the transmission channel switching method, the transmission channels comprise at least one Wi-Fi transmission channel and at least one MD transmission channel.

According to an embodiment of the invention, in the transmission channel switching method, the processor of the communication apparatus 120 may determine whether the channel quality of the default transmission channel meeting a switching condition, and determine whether the power consumption corresponding to the default transmission channel is higher than a threshold.

According to an embodiment of the invention, in the transmission channel switching method, the switching condition may be associated with at least one of a transmission timeout time, a signal quality, a packet error rate, a block error rate, a network congestion status, and a network latency time.

According to an embodiment of the invention, in the transmission channel switching method, when the channel quality of the default transmission channel does not meet the switching condition and the power consumption corresponding to the default transmission channel is not higher than the threshold, the processor of the communication apparatus 120 may keep using the default transmission channel to transmit the data.

According to an embodiment of the invention, in the transmission channel switching method, when the channel quality of the default transmission channel meets the switching condition, the processor of the communication apparatus 120 may determine whether there is a second transmission channel of the plurality of transmission channels whose channel quality does not meet the switching condition. When there is a second transmission channel whose channel quality does not meet the switching condition, the processor of the communication apparatus 120 may switch to the second transmission channel.

According to an embodiment of the invention, in the transmission channel switching method, when there is no transmission channel whose channel quality does not meet the switching condition, the processor of the communication apparatus 120 may transmit the data through a dual-channel transmission mode. According to an embodiment of the invention, in the transmission channel switching method, when there is at least one transmission channel whose channel quality does not meet the switching condition, the processor of the communication apparatus 120 may switch back to a single-channel transmission mode.

According to an embodiment of the invention, in the transmission channel switching method, when the power consumption corresponding to the second transmission channel is higher than the threshold, the processor of the communication apparatus 120 may determine whether there is at least one transmission channel whose channel quality does not meet the switching condition. According to an embodiment of the invention, in the transmission channel switching method, when there is at least one transmission channel whose channel quality does not meet the switching condition, the processor of the communication apparatus 120 may switch from the second transmission channel to a transmission channel whose channel quality does not meet the switching condition.

According to the transmission channel switching method provided in the invention, the communication apparatus (or UE) can consider both the network latency and the power consumption of the communication apparatus at the same time to achieve better user experience.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A transmission channel switching method, comprising:
establishing, by a processor of an apparatus, a plurality of transmission channels;
transmitting, by the processor, data through a default transmission channel of the plurality of transmission channels, wherein the default transmission channel corresponds to the lowest power consumption; and
determining, by the processor, whether to switch to another transmission channel of the plurality of transmission channels according to channel quality of each transmission channel and power consumption corresponds to each transmission channel.

2. The transmission channel switching method of claim 1, wherein the transmission channels comprise at least one Wi-Fi transmission channel and at least one modem (MD) transmission channel.

3. The transmission channel switching method of claim 1, wherein the transmission channels comprise a plurality of Wi-Fi transmission channels and a plurality of modem (MD) transmission channels, and at least one default Wi-Fi transmission channel and at least one default MD transmission channel are selected by the processor according to the channel quality and the power consumption corresponding to each Wi-Fi transmission channel and each MD transmission channel, respectively.

4. The transmission channel switching method of claim 1, wherein the determining whether to switch to another transmission channel comprises:
determining, by the processor, whether the channel quality of the default transmission channel meeting a switching condition; and
determining, by the processor, whether the power consumption corresponding to the default transmission channel is higher than a threshold.

5. The transmission channel switching method of claim 4, wherein the switching condition is associated with at least one of a transmission timeout time, a signal quality, a packet error rate, a block error rate, a network congestion status, and a network latency time.

6. The transmission channel switching method of claim 4, wherein in response to the channel quality of the default transmission channel not meeting the switching condition and the power consumption corresponding to the default transmission channel being not higher than the threshold, the method further comprises:
keeping, by the processor, using the default transmission channel to transmit the data.

7. The transmission channel switching method of claim 4, wherein in response to the channel quality of the default transmission channel meeting the switching condition, the method further comprises:
determining, by the processor, whether there is a second transmission channel of the plurality of transmission channels whose channel quality does not meet the switching condition; and
switching, by the processor, to the second transmission channel in response to there being the second transmission channel whose channel quality does not meet the switching condition.

8. The transmission channel switching method of claim 7, further comprising:
transmitting, by the processor, the data through a dual-channel transmission mode in response to there being no transmission channel whose channel quality does not meet the switching condition.

9. The transmission channel switching method of claim 8, further comprising:
switching, by the processor, back to a single-channel transmission mode in response to there being at least one transmission channel whose channel quality does not meet the switching condition.

10. The transmission channel switching method of claim 7, further comprising:
determining, by the processor, whether there is at least one transmission channel whose channel quality does not meet the switching condition in response to the power consumption corresponding to the second transmission channel being higher than the threshold.

11. The transmission channel switching method of claim 10, further comprising:
switching, by the processor, from the second transmission channel to one transmission channel whose channel quality does not meet the switching condition in response to there being at least one transmission channel whose channel quality does not meet the switching condition.

12. A transmission channel switching apparatus, comprising:
a modem module, configured to perform wireless transmission and reception to and from a network node;
a Wi-Fi module, configured to perform Wi-Fi transmission and reception; and
a processor, coupled to the modem module and the Wi-Fi module, and configured to:
establish a plurality of transmission channels;
transmit, via the modem module or the Wi-Fi module, data through a default transmission channel of the plurality of transmission channels, wherein the default transmission channel corresponds to the lowest power consumption; and
determine whether to switch to another transmission channel of the plurality of transmission channels according to channel quality of each transmission channel and power consumption corresponding to each transmission channel.

13. The transmission channel switching apparatus of claim 12, wherein the transmission channels comprise at least one Wi-Fi transmission channel and at least one modem (MD) transmission channel.

14. The transmission channel switching apparatus of claim 12, wherein the processor is further configured to:
determine whether the channel quality of the default transmission channel meets a switching condition; and
determine whether the power consumption corresponding to the default transmission channel is higher than a threshold.

15. The transmission channel switching apparatus of claim 14, wherein the switching condition is associated with at least one of a transmission timeout time, a signal quality, a packet error rate, a block error rate, a network congestion status, and a network latency time.

16. The transmission channel switching apparatus of claim 14, wherein in response to the channel quality of the default transmission channel not meeting the switching condition and the power consumption corresponding to the default transmission channel is not higher than the threshold, the processor is further configured to:
keep using the default transmission channel to transmit the data.

17. The transmission channel switching apparatus of claim 14, wherein in response to the channel quality of the default transmission channel meeting the switching condition, the processor is further configured to:
determine whether there is a second transmission channel of the plurality of transmission channels whose channel quality does not meet the switching condition; and
switch to the second transmission channel in response to there being the second transmission channel whose channel quality does not meet the switching condition.

18. The transmission channel switching apparatus of claim 17, wherein the processor is further configured to:
transmit the data through a dual-channel transmission mode in response to there being no transmission channel whose channel quality does not meet the switching condition.

19. The transmission channel switching apparatus of claim 18, wherein the processor is further configured to:
switch back to a single-channel transmission mode in response to there being at least one transmission channel whose channel quality does not meet the switching condition.

20. The transmission channel switching apparatus of claim 17, wherein the processor is further configured to:
determine whether there is at least one transmission channel whose channel quality does not meet the switching condition in response to the power consumption corresponding to the second transmission channel being higher than the threshold.

21. The transmission channel switching apparatus of claim 20, wherein the processor is further configured to:
switch from the second transmission channel to one transmission channel whose channel quality does not meet the switching condition in response to there being at least one transmission channel whose channel quality does not meet the switching condition.
